(19) United States
(12) Patent Application Publication
(10) Pub. No.: US 2006/0003038 A1
(43) Pub. Date: Jan. 5, 2006

(54) Injection molding machine shooting pot with integral check valve

(76) Inventor: Nicholas W. Serniuck, Oakville (CA)

Correspondence Address: KATTEN MUCHIN ROSENMAN LLP, 525 WEST MONROE STREET, CHICAGO, IL, 60661-3693, US

(21) Appl. No.: 10/879,576

(22) Filed: Jun. 30, 2004

(51) Int. Cl. B29C 45/13

(52) U.S. Cl. 425/130; 425/557

(57) ABSTRACT

An injection molding shooting pot assembly check valve configured to be installed in a coinjection hot runner with a coinjection nozzle, the coinjection nozzle having at least two melt channels ending at the same gate includes a valve inlet and a valve outlet. A check valve occlusion (preferably a ball) is configured to (i) be disposed integral with or immediately adjacent the shooting pot assembly, and (ii) prevent resin leakage to the valve inlet in response to a melt discharge operation of the shooting pot assembly. Preferably, more than one such shooting pot assembly with integral check valve is provided in a coinjection molding machine.

### BACKGROUND OF THE INVENTION

1. Field of the Invention

The present invention relates to an improved check valve assembly incorporated within the body of a shooting pot cylinder of a coinjection hot runner assembly in an injection molding machine.

2. Description of Related Art

Coinjection molding is typically used to mold multi-layered plastic packaging articles having a laminated wall structure. Each layer is typically passed through a different annular or circular passageway in a single nozzle structure and each layer is partially, sequentially, injected through the same gate. Some coinjection hot runner systems include shooting pots to meter material of one plastic resin so that each cavity of a multi-cavity mold receives an accurate dose of that resin in the molding cycle. Some design configurations use check valves to prevent backflow of the resin when the shooting pot discharges the resin through the nozzle.

U.S. Pat. No. 4,717,324 to Schad discloses an coinjection hot runner assembly, with shooting pots, that does not use check valves. Instead, rotary valves are used to prevent backflow of the resins during injection from the shooting pots. Rotary valves required external actuation mechanisms which increase cost and complication, also rotary valves are prone to leaking resin.

U.S. Pat. No. 4,710,118 to Krishnakumar discloses an coinjection hot runner assembly with shooting pots that uses check valves to prevent backflow of resin during injection from the shooting pots. In this patent, the check valves are represented schematically and are shown as enclosed within the manifold, as part of the melt channel. There is no teaching of how the check valves are installed or how they may be serviced, if required. See also:

U.S. patent application Ser. No. 10/______ entitled INJECTION MOLDING MACHINE SPIGOTTED SHOOTING POT PISTON (attorney docket number 213201.00213; H-784);

U.S. patent application Ser. No. 10/______ entitled APPARATUS AND METHOD FOR SEALING INJECTION UNIT AND SPRUE (attorney docket number 213201.00215; H-785);

U.S. patent application Ser. No. 10/______ entitled APPARATUS AND METHOD FOR ACTUATION OF INJECTION MOLDING SHOOTING POTS (attorney docket number 213201.00216; H-781);

U.S. patent application Ser. No. 10/______ entitled CONTROL SYSTEM FOR A DYNAMIC FEED COINJECTION PROCESS (attorney docket number 213201.00221; H-786);

U.S. patent application Ser. No. 10/_____ entitled HOT RUNNER COINJECTION NOZZLE WITH THERMALLY SEPARATED MELT CHANNELS (attorney docket number 213201.00219; H-788);

U.S. patent application Ser. No. 10/______ entitled COINJECTION MOLDING COOLED SHOOTING POT (attorney docket number 213201.00223; H-783); and

U.S. patent application Ser. No. 10/______ entitled APPARATUS AND METHOD FOR INJECTION MOLDING SHOOTING POT WEDGE FEATURE (attorney docket number 213201.00220; H-780).

FIGS. 1-3 show a known check valve configuration installed in a coinjection hot runner manifold. The installation is remote from the shooting pot assembly and occupies space that could otherwise be saved to decrease the size of the overall assembly. FIG. 3 shows the detail of the assembly, namely an insert 10, containing a melt channel 11 in which there is a ball (or other occlusion) 12, that is retained by a cross dowel 13. This insert is retained in the manifold by a plate 14, and oriented to the plate by dowel 15 to ensure the inlet/outlet to the melt channel 11 is aligned with the corresponding channel(s) in the manifold (not shown). There is typically one installation for each shooting pot, consequently in a two material coinjection hot runner for a 48 cavity mold, there would be at least 12 check valve installations.

Thus, what is needed is a shooting pot check valve assembly which is easily installed, easily maintained, reliable, and takes up minimal space in the neighborhood of the shooting pot.

### SUMMARY OF THE INVENTION

It is an advantage of the present invention to provide shooting pot check valve method and apparatus whereby injected resin is forcible and reliably prevented from leaking back into the injection melt channel, while making installation and maintenance more efficient and less costly.

According to a first aspect of the present invention, a unique combination of structure and/or steps is provided for an injection molding shooting pot assembly check valve configured to be installed in a coinjection hot runner with a coinjection nozzle, where the coinjection nozzle has at least two melt channels ending at the same gate. The check valve preferably includes a valve inlet, and a valve outlet. An check valve occlusion is configured to (i) be disposed integral with or immediately adjacent the shooting pot assembly, and (ii) prevent resin leakage to the valve inlet in response to a melt discharge operation of the shooting pot assembly.

According to a second aspect of the present invention, a unique combination of structure and/or steps is provided for an injection molding shooting pot assembly check valve configured to be installed in a coinjection hot runner with a coinjection nozzle, the coinjection nozzle having at least two melt channels ending at the same gate. Preferably, the check valve includes an inlet melt channel and an outlet melt channel configured to provide melt to the coinjection nozzle. A shooting pot cylinder is disposed between the inlet melt channel and the outlet melt channel. A shooting pot piston is configured to move within the shooting pot cylinder to discharge melt from the shooting pot cylinder to the outlet melt channel. A check valve is disposed integral with or immediately adjacent the shooting pot cylinder and is configured to prevent melt leakage to the melt inlet channel in response to the discharge of melt from the shooting pot cylinder.

According to a third aspect of the present invention, a unique combination of structure and/or steps is provided for an injection molding shooting pot assembly check valve configured to be installed in a coinjection hot runner with a coinjection nozzle, the coinjection nozzle having at least two melt channels ending at the same gate. The check valve includes a shooting pot piston, and a shooting pot cylinder that is configured to discharge melt to an outlet melt channel upon activation of the shooting pot piston. A check valve is disposed integral with or immediately adjacent to the shooting pot cylinder, and is configured to reduce leakage of melt from the shooting pot cylinder to an inlet melt channel in response to at least partial discharge of the melt from the shooting pot cylinder upon activation of the shooting pot piston.

According to a fourth aspect of the present invention, a unique combination of structure and/or steps is provided for an injection molding shooting pot assembly check valve configured to be installed in a coinjection hot runner with a coinjection nozzle, the coinjection nozzle having at least two melt channels ending at the same gate. The check valve includes a shooting pot cylinder, and means for causing a check valve occlusion to move within a check valve chamber that is disposed integral with or immediately adjacent to the shooting pot cylinder, to cause the melt to at least partially fill the shooting pot cylinder. Means are provided for discharging the melt from the shooting pot cylinder through a melt outlet channel, and through a coinjection nozzle into a mold cavity. The means for discharging causes the check valve occlusion to move within a check valve chamber to substantially reduce melt leakage from said shooting pot cylinder to a melt inlet channel.

### BRIEF DESCRIPTION OF THE DRAWINGS

Exemplary embodiments of the presently preferred features of the present invention will now be described with reference to the accompanying drawings.

FIG. 1 is a schematic view of a known coinjection hot runner manifold assembly.

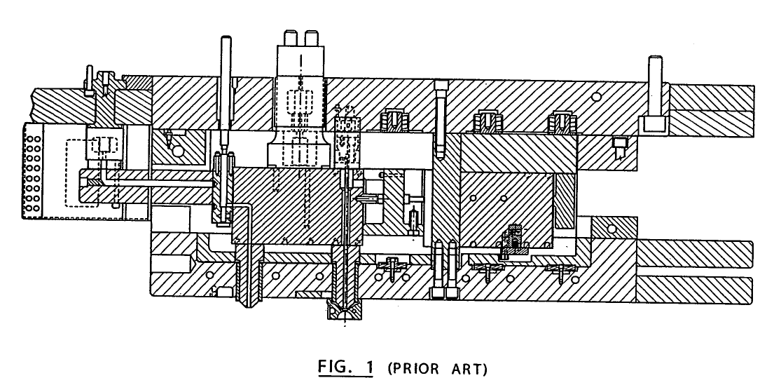

FIG. 2 is an enlarged view of FIG. 1 showing a check valve location.

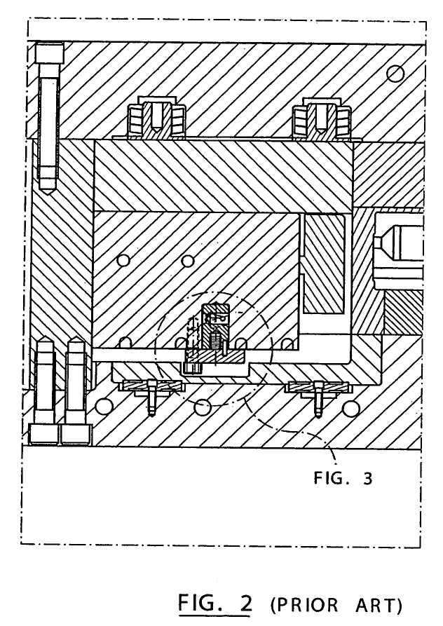

FIG. 3 is an enlarged view of FIG. 2 showing the check valve assembly.

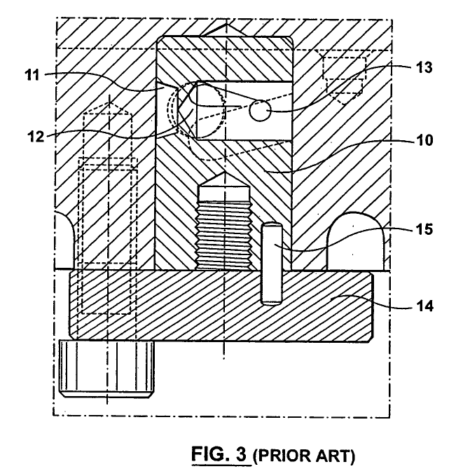

FIG. 4 is a schematic view of part of a coinjection hot runner manifold assembly according to a first embodiment of the present invention.

FIG. 5 is a schematic view of part of a coinjection hot runner manifold assembly according to a second embodiment of the present invention.

FIG. 6 is a schematic view of part of a coinjection hot runner manifold assembly showing a further alternative according to the preferred embodiments of the present invention.

### DETAILED DESCRIPTION OF THE PRESENTLY PREFERRED EXEMPLARY EMBODIMENTS

1. Introduction

The present invention will now be described with respect to several embodiments in which an integral check valve is used in the shooting pot of a plastic coinjection molding machine. The coinjection process is partially injecting a first material through the gate followed by partially injecting a second material through the same gate.

2. The structure of the First Embodiment

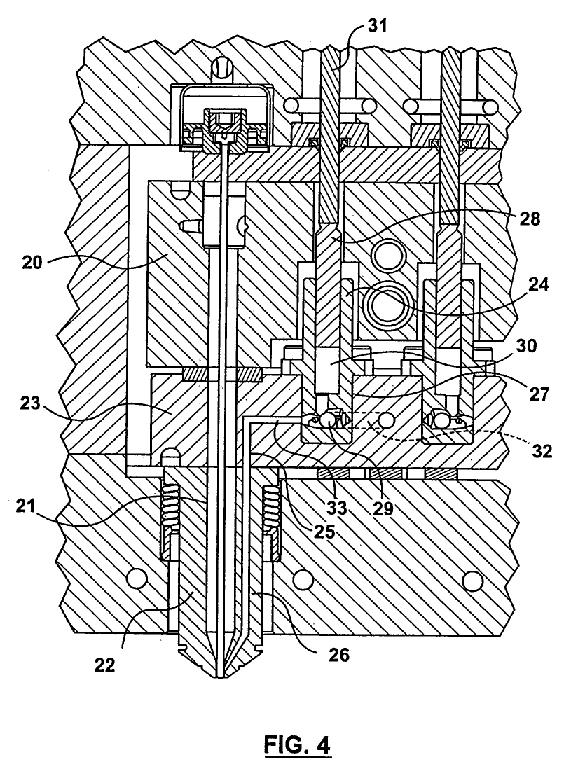

FIG. 4 shows a portion of a coinjection hot runner assembly according to the first embodiment according to the present invention. A first manifold 20 has shooting pots and melt channels (not shown) for supplying a first resin “A” to a first melt channel 21 in a nozzle 22. A second manifold 23 has at least one shooting pot assembly 24 connected via a melt channel 25 for supplying second resin “C” to a second melt channel 26 in the nozzle 22. The first melt channel 21 and the second melt channel 26 exit the nozzle 22 at the same gate opening. The shooting pot assembly 24 preferably comprises a shooting pot cylinder 27, a shooting pot piston 28, and a check valve 29. The check valve 29 is preferably housed within or partially within (i.e., integral with) the shooting pot cylinder 27. Alternatively, the check valve 29 could be disposed immediately adjacent to the shooting pot cylinder 27, in order to conserve space. Also, the preferred embodiment may be adapted for use in nozzles which co-inject three, four, or more resins. 21 Preferably, the shooting pot assembly 24 is set into the second manifold 23 such that the melt channels therein are aligned with an inlet channel 32 and an outlet 33 channel leading to/from the check valve 29 and shooting pot chamber 30, respectively. With this arrangement, the check valve 29 will act to prevent resin from leaking back into the melt channel when the shooting pot is discharged. Preferably, a check valve 29 is provided for each shooting pot. The check valve 29 may be of any size and shape, depending upon the application.

In the FIG. 4 embodiment, the check ball has a ball diameter of about 6.0 mm, a shooting pot piston diameter of about 10.0 mm, and a shooting pot cylinder overall length of about 83.0 mm. However, these dimensions can vary tremendously in size depending on the application.

3. The Method of the First Embodiment

In operation, resin supplied from the injection unit (not shown) via the inlet channel 32 of the second manifold 23 flows past the check valve 29 to fill the shooting pot chamber 30, thereby displacing the shooting pot piston 28 upward until the predetermined shot size for the chamber 30 is made. The forward (downward) actuation of the shooting pot piston 28 by an actuator 31 causes the “C” resin in the shooting pot chamber 30 to be moved out along channels 25 and 26 to enter the mold cavity (not shown). The movement of the “C” resin by the piston 28 also causes the check valve to block the inlet channel 32 in shooting pot cylinder 27, thereby preventing backflow of the “C” resin towards the injection unit. By including the check valve within, partially within, or adjacent to the shooting pot cylinder, the costs of manufacture, assembly, and maintenance are reduced, and space is saved in the hot runner assembly.

4. The Structure of the Second Embodiment

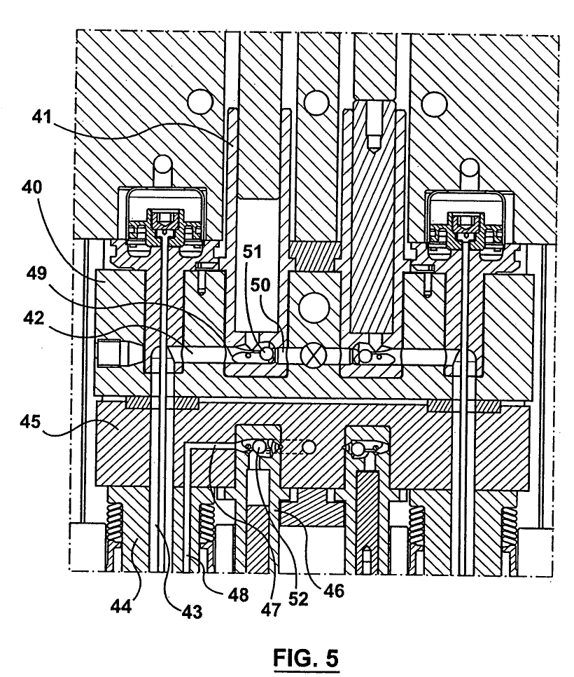

FIG. 5 shows a second embodiment of the present invention in which shooting pots are shown in both manifolds of a coinjection hot runner assembly. A first manifold 40 has at least one first shooting pot 41 assembly, and a melt channel 42 for supplying the first resin “A” to a melt channel 43 in the nozzle 44. A first check valve 51 is disposed within the first shooting pot assembly 41. Both the inlet channel 50 and the outlet channel 49 of the check valve 51 are aligned transverse to the centerline of the shooting pot 41.

A second manifold 45 has at least one second shooting pot assembly 46 connected via a melt channel 47 for supplying second resin “C” to a melt channel 48 in the nozzle 44. A second check valve 52 is disposed within the second shooting pot assembly 46. Again, both the inlet channel 53 and the outlet channel 54 of the check valve 52 are aligned transverse to the centerline of the shooting pot 46. The compact configuration of each shooting pot assembly containing its respective check valve allows the shooting pots in the two manifolds to be aligned coaxially, That is, shooting pot 46 is directly beneath shooting pot 41, thereby optimizing the transverse space requirement for housing the shooting pots in their respective manifolds.

5. The Method of the Second Embodiment

In operation, the shooting pots are actuated simultaneously or sequentially according the to the coinjection molding process being employed, and their check valves operate to prevent backflow, as described above with respect to the first embodiment.

6. The Structure of a Further Alternative

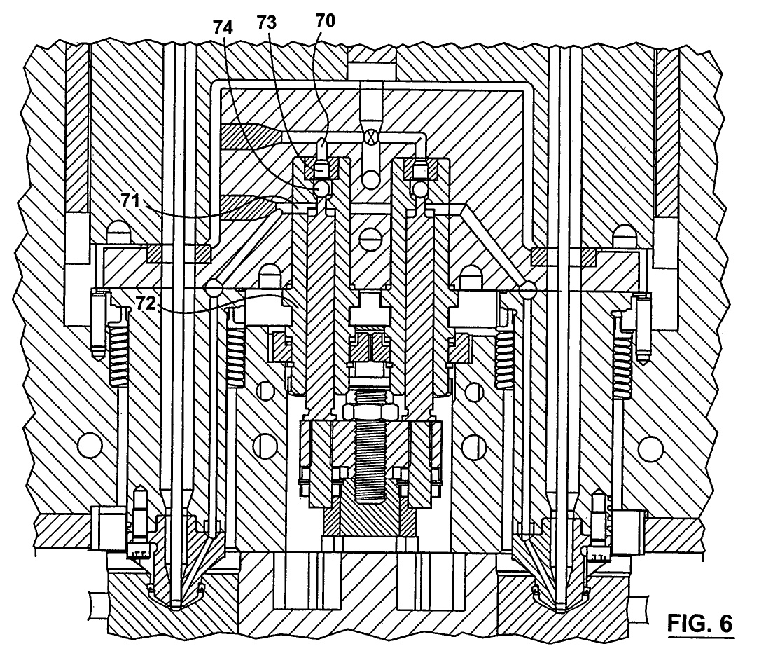

FIG. 6 shows the preferred embodiments of the invention in which the inlet channel 70 is aligned coaxially with the centerline of the shooting pot 72, and the outlet channel 71 is transverse to the centerline of the shooting pot 72. This configuration allows the check valve chamber 73 to be extended to allow more travel for the ball, thereby enhancing decompression and/or suckback of the shooting pot. See, for example, U.S. patent application Ser. No. 10/______ entitled “CONTROL SYSTEM FOR DYNAMIC FEED COINJECTION PROCESS” (attorney docket no. 213201,00221; H-786). For example, the check valve chamber my be equal to or greater than twice the diameter of the check valve ball 74. The previously-described embodiments aligned the check valve chamber transverse to the shooting pot centerline and consequently were limited in chamber length by the diameter of the shooting pot cylinder. In the FIG. 7 6 embodiment, the length of the chamber faces no such restriction.

8. Conclusion

Advantageous features according to the present invention may include:
In a coinjection hot runner assembly, a shooting pot cylinder containing its own check valve and the associated inlet and outlet channels.
Aligning the check valve within the shooting pot cylinder so that the inlet and/or outlet channels can be oriented either coaxial to the shooting pot centerline or transverse thereto.
Aligning the inlet channel coaxially with the shooting pot centerline provides space to extend the check valve chamber thereby providing a decompression/suckback capability in the configuration.

Thus, what has been described is a method and apparatus for efficiently disposing a check valve within, partially within, or adjacent to the shooting pot assembly to provide enhanced sealing, reduced space requirements, and lower assembly and maintenance costs.

The individual components shown in outline or designated by blocks in the attached Drawings are all well-known in the injection molding arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. patent documents discussed above are hereby incorporated by reference into the Detailed Description of the Preferred Embodiment.

What is claimed is:

1. An injection molding shooting pot assembly check valve configured to be installed in a coinjection hot runner with a coinjection nozzle, the coinjection nozzle having at least two melt channels ending at the same gate, comprising:
a valve inlet;
a valve outlet;
an occlusion configured to (i) be disposed integral with or immediately adjacent the shooting pot assembly, and (ii) prevent resin leakage to said valve inlet in response to a melt discharge operation of the shooting pot assembly.

2. A check valve according to claim 1, wherein said occlusion is configured to be disposed within a shooting pot cylinder of the shooting pot assembly.

3. A check valve according to claim 2, wherein said valve inlet and said valve outlet are configured to be disposed within the shooting pot cylinder of the shooting pot assembly.

4. A check valve according to claim 1, further comprising a check valve chamber, and wherein said occlusion is configured as a ball that moves within said check valve chamber in response to discharge of the shooting pot assembly.

5. A check valve according to claim 4, wherein said check valve chamber is configured to be at least twice as long as the diameter of said check valve ball.

6. A check valve according to claim 1, wherein at least one of said valve inlet and said valve outlet is disposed coaxial with a centerline of the shooting pot assembly.

7. An injection molding shooting pot assembly check valve configured to be installed in a coinjection hot runner with a coinjection nozzle, the coinjection nozzle having at least two melt channels ending at the same gate, comprising:
an inlet melt channel;
an outlet melt channel configured to provide melt to the coinjection nozzle;
a shooting pot cylinder disposed between said inlet melt channel and said outlet melt channel;
a shooting pot piston configured to move within said shooting pot cylinder to discharge melt from said shooting pot cylinder to said outlet melt channel; and
a check valve disposed integral with or immediately adjacent said shooting pot cylinder and configured to prevent melt leakage to said melt inlet channel in response to the discharge of melt from said shooting pot cylinder.

8. A check valve according to claim 7, further comprising:
a second inlet melt channel;
an second outlet melt channel configured to provide a second melt to the coinjection nozzle;
a second shooting pot cylinder disposed between said second inlet melt channel and said second outlet melt channel;
a second shooting pot piston configured to move within said second shooting pot cylinder to discharge the second melt from said second shooting pot cylinder to said second outlet melt channel; and
a second check valve disposed immediately adjacent said second shooting pot cylinder and configured to prevent leakage of the second melt to said second melt inlet channel in response to the discharge of melt from said second shooting pot cylinder.

9. A check valve according to claim 7, wherein said shooting pot cylinder and said second shooting pot cylinder are disposed substantially co-linear.

10. A check valve according to claim 9, wherein one of said inlet melt channel and said outlet melt channel is disposed substantially transverse to a longitudinal axis of said shooting pot cylinder, and wherein the other one of said inlet melt channel and said outlet melt channel is disposed substantially parallel to the longitudinal axis of said shooting pot cylinder.

11. A check valve according to claim 10, wherein said check valve comprises a ball disposed within a check valve chamber, and wherein said check valve chamber has a length at least twice the diameter of said check valve ball.

12. A check valve according to claim 11, wherein the length of said check valve chamber has a length greater than twice the diameter of said check valve ball.

13. A check valve according to claim 7, wherein said check valve comprises:
a check valve inlet in fluid communication with said inlet melt channel;
a check valve outlet in fluid communication with said outlet melt channel;
a check valve chamber; and
a check valve occlusion configured to (i) move to a first position upon transmission of melt from said inlet melt channel through said check valve inlet into said shooting pot cylinder, and (ii) move to a second position to reduce leakage of melt into said inlet melt channel in response to movement of melt from the shooting pot cylinder to said outlet melt channel.

14. An injection molding shooting pot assembly check valve configured to be installed in a coinjection hot runner with a coinjection nozzle, the coinjection nozzle having at least two melt channels ending at the same gate, comprising:
a shooting pot piston;
a shooting pot cylinder configured to discharge melt to an outlet melt channel upon activation of said shooting pot piston; and
a check valve disposed integral with or immediately adjacent to said shooting pot cylinder, and configured to reduce leakage of melt from said shooting pot cylinder to an inlet melt channel in response to at least partial discharge of the melt from said shooting pot cylinder upon activation of said shooting pot piston.

15. A check valve according to claim 14, further comprising:
a second shooting pot piston;
a second shooting pot cylinder configured to discharge a second melt upon activation of said second shooting pot piston; and
a second check valve disposed within or immediately adjacent to said second shooting pot cylinder, and configured to reduce leakage of the second melt from said second shooting pot cylinder in response to at least partial discharge of the second melt from said second shooting pot cylinder upon activation of said second shooting pot piston.

16. A check valve according to claim 15, wherein longitudinal axes of said shooting pot cylinder and said second shooting pot cylinder are substantially co-linear.

17. A check valve according to claim 14, further comprising a check valve ball disposed within a check valve chamber, said check valve chamber having a length that is equal to or greater than twice the diameter of said check valve ball.

18. A check valve according to claim 17, wherein a longitudinal axis of said shooting pot cylinder is disposed substantially co-axial to at least a portion of at least one of the inlet melt channel and the outlet melt channel.

19. An injection molding shooting pot assembly check valve configured to be installed in a coinjection hot runner with a coinjection nozzle, the coinjection nozzle having at least two melt channels ending at the same gate, comprising:
a shooting pot cylinder configured to be disposed at least partially within a manifold;
a shooting pot piston disposed at least partially within said shooting pot cylinder;
a check valve chamber integral with or immediately adjacent to said shooting pot cylinder; and
a check valve occlusion disposed within said check valve chamber.

20. An injection molding shooting pot assembly check valve configured to be installed in a coinjection hot runner with a coinjection nozzle, the coinjection nozzle having at least two melt channels ending at the same gate, comprising:
a shooting pot cylinder;
means for causing a check valve occlusion to move within a check valve chamber that is disposed integral with or immediately adjacent to the shooting pot cylinder, to cause the melt to at least partially fill the shooting pot cylinder;
means for discharging the melt from the shooting pot cylinder through a melt outlet channel, and through a coinjection nozzle into a mold cavity; and
the means for discharging causing the check valve occlusion to move within a check valve chamber to substantially reduce melt leakage from said shooting pot cylinder to a melt inlet channel.
